(19) United States
(12) Patent Application Publication
(10) Pub. No.: US 2021/0317346 A1
(43) Pub. Date: Oct. 14, 2021

(54) HOT MELT ADHESIVE COMPOSITIONS WITH HIGH BIO-BASED CONTENT

(71) Applicant: H.B. Fuller Company, St. Paul, MN (US)

(72) Inventors: Tara Misra, Charlotte, NC (US); Thomas F. Kauffman, Woodbury, MN (US); Ameara S. Mansour, Woodbury, MN (US)

(21) Appl. No.: 17/182,991

(22) Filed: Feb. 23, 2021

Related U.S. Application Data
(60) Provisional application No. 63/007,502, filed on Apr. 9, 2020.

(51) Int. Cl. C09J 123/06; C09J 5/06; C09J 11/06; C09J 153/00; C09J 123/12

(52) U.S. Cl. CPC C09J 123/06; C09J 5/06; C09J 2401/006; C09J 153/00; C09J 123/12; C09J 11/06

(57) ABSTRACT

The invention is directed to hot melt adhesive compositions that can be formulated to include a large percentage of bio-based components.

The hot melt adhesive composition includes both liquid bio-based tackifying agent and solid bio-based tackifying agent and can further include bio-based polymers and bio-based plasticizers.

This application claims the benefit of U.S. Provisional Patent Application No.: 63/007, 502 filed on Apr. 9, 2020, which is incorporated herein.

### BACKGROUND

In the area of industrial adhesives, hot melt adhesive compositions are commonly used to bond together a wide variety of articles including tapes, labels, and disposable absorbent articles comprising non-woven substrates e.g. adult incontinence products, disposable diapers, sanitary napkins, bed pads, puppy pads, medical dressings, etc.

Hot melt adhesive compositions include materials such as polymers, tackifying agents, plasticizers and waxes. Such materials are commonly derived from petroleum based feedstocks. It would be desirable if the majority, or even the entirety of the hot melt adhesive composition could be formed of bio-based components.

### SUMMARY

In one aspect, the invention features a hot melt adhesive composition including, a thermoplastic polymer, a first tackifying agent that is bio-based and solid at room temperature, and a second tackifying agent that is bio-based and liquid at room temperature, wherein the hot melt adhesive composition includes greater than 70% by weight of bio-based components and wherein the second tackifying agent is present in a greater amount than the first tackifying agent.

In one embodiment, the hot melt adhesive composition includes a total tackifying agent content of 65% by weight to 85% by weight, or even a total tackifying agent content of 65% by weight to 95% by weight. In a different embodiment, the first and second tackifying agents are selected from the group consisting of terpenes, modified terpenes, natural rosins, modified rosins, rosin esters and hydrogenated versions thereof. In another embodiment, the hot melt adhesive composition includes from 15% by weight to 65% by weight of the first tackifying agent and from 10% by weight to 75% by weight of the second tackifying agent.

In another embodiment, the thermoplastic polymer is selected from the group consisting of bio-based, recycled, and combinations thereof. In a different embodiment, the hot melt adhesive composition includes from 80% by weight to 100% by weight of bio-based components, or even 100% by weight of bio-based components. In one embodiment, the hot melt adhesive composition additionally includes a bio-based plasticizer. In one embodiment, the bio-based plasticizer is derived from a plant oil.

In another embodiment, the hot melt adhesive composition includes from 10% by weight to 25% by weight of the thermoplastic polymer, from 10% by weight to 70% by weight of the first tackifying agent, and from 10% by weight to 70% by weight of the second tackifying agent. In still another embodiment, the hot melt adhesive composition includes from 10% by weight to 25% by weight of the thermoplastic polymer, from 10% by weight to 30% by weight of the first tackifying agent, from 45% by weight to 65% by weight of the second tackifying agent, and from 2% by weight to 15% by weight of a bio-based plasticizer. In a different embodiment, the hot melt adhesive composition includes from 3% by weight to 25% by weight of the thermoplastic polymer, from 10% by weight to 70% by weight of the first tackifying agent, and from 10% by weight to 80% by weight of the second tackifying agent.

In one embodiment, the thermoplastic polymer is selected from the group consisting of propylene based polymers, ethylene based polymers and styrene block copolymers. In another embodiment, the thermoplastic polymer is single site catalyzed. In still another embodiment, the thermoplastic polymer comprises a functionalized polymer. In a different embodiment, the hot melt adhesive composition has a Brookfield Viscosity of from 2,000 cP to 15,000 cP at 121° C. In still another embodiment, the hot melt adhesive composition has a Wet Dynamic Peel of from 30 gf/cm to 500 gf/cm.

In another aspect, the invention features a hot melt adhesive composition including from 5% by weight to 25% by weight of a functionalized thermoplastic polymer, from 10% by weight to 70% by weight of a first tackifying agent that is bio-based and solid at room temperature, from 10% by weight to 70% by weight of a second tackifying agent that is bio-based and liquid at room temperature, and optionally less than 25% by weight of a bio-based plasticizer, wherein the hot melt adhesive composition has a total tackifier content of greater than 65% by weight.

In one embodiment, the functionalized thermoplastic polymer is an ethylene based single-site catalyzed polymer. In another embodiment, the functionalized thermoplastic polymer is selected from the group consisting of bio-based, recycled and combinations thereof. In a different embodiment, the thermoplastic polymer is functionalized with a material selected from the group consisting of carboxylic acid, maleic anhydride, and combinations thereof.

In another embodiment, the hot melt adhesive composition includes from 5% by weight to 25% by weight of the functionalized thermoplastic polymer, from 40% by weight to 65% by weight of the first tackifying agent, from 10% by weight to 25% by weight of the second tackifying agent, and from 5% by weight to 25% by weight a second thermoplastic polymer that is not functionalized.

In one embodiment, the invention features an article selected from the group consisting of a tape, label and disposable absorbent article include the hot melt adhesive composition of this invention. In another embodiment, the invention includes a disposable absorbent article including a first substrate, a second substrate, and the hot melt adhesive composition, wherein the hot melt adhesive composition is applied to at least one of the first and second substrates. In another embodiment, at least one of the substrates is bio-based. In one embodiment, the bio-based substrate is cotton.

In a third aspect, the invention features a hot melt adhesive composition including from 3% by weight to 25% by weight of a thermoplastic polymer, from 10% by weight to 70% by weight of a first tackifying agent that is bio-based and solid at room temperature, from 10% by weight to 80% by weight of a second tackifying agent that is bio-based and liquid at room temperature, and optionally less than 25% by weight of a bio-based plasticizer, wherein the hot melt adhesive composition comprises greater than 80% by weight of bio-based components.

In one embodiment, the hot melt adhesive composition includes from 5% by weight to 25% by weight of the thermoplastic polymer, from 45% by weight to 70% by weight of the first tackifying agent, from 10% by weight of 25% by weight of the second tackifying agent, and from 2% by weight to 15% by weight of a bio-based plasticizer, wherein the thermoplastic polymer is a styrene block copolymer. In another embodiment, the thermoplastic polymer is selected from the group consisting of bio-based, recycled, and combinations thereof.

Applicants have discovered hot melt adhesive compositions for tapes, labels, and disposable absorbent articles that can be formulated to have a high percentage of bio-based components and still provide superior properties that are comparable and in some cases better, when compared to non-bio-based hot melt compositions.

### DETAILED DESCRIPTION OF THE INVENTION

### Definitions

“Renewable resource” is used herein to refer to a resource that is produced by a natural process at a rate comparable to its rate of consumption. The resource can be replenished naturally or by engineered agricultural techniques. Examples of renewable resources include but are not limited to plants (e.g., sugar cane, beets, corn, potatoes, citrus fruit (e.g. oranges), woody plants, cellulosic waste, etc.), animals, fish, bacteria, fungi, and forestry products (e.g. pine and spruce trees). These resources can be naturally occurring, hybrids, or genetically engineered organisms. Natural resources such as crude oil, coal and natural gas are not considered renewable as they are derived from materials that will run out or will not be replenished for thousands or even millions of years.

“Bio-based” is used herein to refer to a component of the hot melt adhesive that is produced or is derived from a renewable resource.

### Hot Melt Adhesive Composition

The hot melt adhesive compositions of this invention include a high weight percent of bio-based components. The bio-based components are produced or derived primarily from renewable resources. The bio-based components can be produced or derived from at least 70% by weight, at least 75% by weight, at least 80% by weight, at least 85% by weight, at least 90% by weight, at least 95% by weight, or even 100% by weight (i.e. entirely) from renewable resources.

The hot melt adhesive composition can include greater than 65% by weight, greater than 70% by weight, greater than 75%, greater than 80% by weight, from 65% by weight to 100% by weight, from 75% by weight to 100% by weight, from 80% by weight to 100% by weight, or even 100% by weight of bio-based components.

The hot melt adhesive composition includes both a first tackifying agent that is a solid bio-based tackifying agent and a second tackifying agent that is a liquid bio-based tackifying agent and can further include bio-based polymers and bio-based plasticizers.

The hot melt adhesive compositions can alternatively include a functionalized (e.g. hydroxyl modified or maleic anhydride modified) thermoplastic polymer. The inventors have discovered that functionalized polymers can improve wet adhesion to bio-based substrates such as cotton.

The hot melt adhesive composition can have a Brookfield Viscosity of from 1,000 cP to 40,000 cP, or even from 2,000 cP to 15,000 cP at 121° C. (250° F.).

The hot melt adhesive composition can have a Wet Dynamic Peel of at least 30 gf/cm, at least 50 gf/cm, from 30 gf/cm to 500 gf/cm, or even from 50 gf/cm to 500 gf/cm.

### Thermoplastic Polymer

The hot melt adhesive composition includes thermoplastic polymer.

The thermoplastic polymer can be bio-based. Bio-produced monomers can be used to make the bio-based thermoplastic polymer. It is anticipated that thermoplastic polymers made with bio-produced monomers will have similar properties to those made with petroleum derived monomers. The bio-produced monomers can be selected from the group consisting of ethylene, propylene, isoprene, butadiene, styrene, etc. However, useful bio-produced monomers are not restricted to this group. Bio-produced monomers are commonly derived from cellulose, starch and sugar e.g. glucose.

Alternatively, the thermoplastic polymer can be derived from petroleum-based materials.

Bio-based and petroleum-based thermoplastic polymers can be combined in the present invention in any ratio, depending on cost and availability. Recycled thermoplastic polymers can also be used, alone or in combination with bio-based and/or petroleum-based thermoplastic polymers.

The thermoplastic polymer can be selected from the group consisting of ethylene homopolymers, ethylene copolymers, propylene homopolymers, propylene copolymers, styrene block copolymers, functionalized versions thereof (e.g., hydroxyl modified or maleic anhydride modified), and blends thereof.

The thermoplastic polymer can be prepared using a variety of catalysts including, e.g., a single site catalyst (e.g., metallocene catalysts (e.g., metallocene catalyzed ethylene alpha-olefin copolymers), constrained geometry catalysts (e.g., homogeneous linear or substantially linear ethylene alpha-olefin interpolymers prepared from ethylene and an alpha-olefin comonomer using a constrained geometry catalyst and having a polydispersity index of no greater than 2.5 and possessing long chain branching)), multiple single site catalysts, Ziegler-Natta catalysts and combinations thereof.

The thermoplastic polymer can include functional groups (i.e. be functionalized) including, e.g., carboxylic acid groups, anhydride groups (e.g., maleic anhydride), and combinations thereof.

The hot melt adhesive composition can include from 3% by weight to 60% by weight, from 10% by weight to 60% by weight, from 10% by weight to 50% by weight, from 10% by weight to 40% by weight, from 10% by weight to 30% by weight, from 3% by weight to 25% by weight, from 10% by weight to 25% by weight, or even from 12% by weight to 20% by weight of thermoplastic polymer.

If the hot melt adhesive composition includes a functionalized thermoplastic polymer, it can also include a second thermoplastic polymer that is not functionalized. The hot melt adhesive composition can include from 3% by weight to 25% by weight, from 5% by weight to 25% by weight, or even from 5% by weight to 15% by weight of the functionalized thermoplastic polymer. The hot melt adhesive composition can further include from 3% by weight to 25% by weight, from 5% by weight to 25% by weight, or even from 5% by weight to 15% by weight of the second thermoplastic polymer that is not functionalized.

If petroleum-based polymer is used, the amount of thermoplastic polymer can be limited to maximize the bio-based material content.

The Melt Flow Rate (MFR), according to ASTM D-1238 (190° C., 2.16 kg), of the polymer is not particularly limited, the MFR can range from 0.5 to 2000.

When the amount of thermoplastic polymer is limited, it can be useful to use a higher molecular weight grade of thermoplastic polymer. The thermoplastic polymer or a portion of the thermoplastic polymer can have a Melt Flow Rate (MFR) according to ASTM D-1238 (190° C., 2.16 kg) of from 2 to 20, or even from 4 to 15.

The polymer can be an ethylene alpha-olefin copolymer having a density of no greater than 0.90 grams per cubic centimeter (g/cm3), or even no greater than 0.88 g/cm3. The alpha-olefin monomer has at least three carbon atoms, or even from three to 20 carbon atoms, suitable examples of which include propylene, isobutylene, butene, pentene, hexene, heptene, octene, nonene, decene, dodecene, 4-methyl-1-pentene, 3-methyl pentene-1,3,5,5-trimethyl-hexene-1, 5-ethyl-1-nonene, and combinations thereof. Specific examples of suitable ethylene copolymers include ethylene-propylene, ethylene-butene, ethylene-hexene, ethyene-octene, and combinations thereof.

Useful ethylene alpha-olefin copolymers are commercially available under of a variety of trade designations including, e.g., the AFFINITY series of trade designations from DowDuPont Chemical Company (Midland, Mich.) including, e.g., AFFINITY GA 1875, AFFINITY GA 1900, and AFFINITY GA 1950 ethylene-octene elastomers, AFFINITY GA 1000R maleic anhydride-modified ethylene-octene copolymer (which is also referred to as an interpolymer by the manufacturer), AFFINITY ethylene-propylene copolymers, and the ENGAGE series of trade designations from DowDuPont Chemical Company (Midland, Mich.) including ENGAGE 8200, ENGAGE 8401, and ENGAGE 8402 ethylene-octene copolymers.

The polymer can be a propylene based polymer. The propylene based polymer can be selected from the group consisting of a propylene alpha olefin copolymer and a propylene homopolymer.

The propylene-alpha-olefin copolymer is derived from propylene and at least one alpha-olefin co-monomer other than propylene (e.g., C2, and C4-C20 alpha-olefin co-monomers, and combinations thereof). Useful alpha-olefin co-monomers include, e.g., alpha-olefin monomers having at least two carbon atoms, at least four carbon atoms, from four carbon atoms to eight carbon atoms, and combinations thereof. Examples of suitable classes of alpha-olefin co-monomers include mono-alpha olefins (i.e., one unsaturated double bond) and higher order alpha olefins (e.g., dienes (e.g., 1,9-decadiene)). Suitable alpha-olefin monomers include, e.g., ethylene, butene, pentene, hexene, heptene, octene, nonene, decene, dodecene, 4-methyl-pentene-1, 3-methyl pentene-1,3,5,5-trimethyl-hexene-1, 5-ethyl-1-nonene, and combinations thereof. Specific examples of suitable propylene-alpha-olefin copolymers include propylene-ethylene, propylene-butene, propylene-hexene, propylene-octene, and combinations thereof.

Useful propylene-alpha-olefin copolymers include, e.g., copolymers, terpolymer, and higher order polymers, mixtures of at least two different propylene-alpha-olefin copolymers, and combinations thereof. Useful propylene-alpha-olefin co polymers also include, e.g., modified, unmodified, grafted, and ungrafted propylene-alpha-olefin copolymers, uni-modal propylene-alpha-olefin polymers, multi-modal propylene-alpha-olefin copolymers, and combinations thereof. The term “multi-modal” means the polymer has a multi-modal molecular weight distribution (weight average molecular weight (Mw)/number average molecular weight (Mn)) as determined by Size Exclusion Chromatography (SEC).

Suitable commercially propylene-alpha-olefin copolymers are available under a variety of trade designations including, e.g., the VISTAMAXX series of trade designations from ExxonMobil Chemical Company (Houston, Tex.) including VISTAMAXX 6202 propylene-ethylene copolymer, VISTAMAXX 8880 propylene-ethylene copolymer, and VISTAMAXX 8380 propylene-ethylene copolymer. Suitable propylene homopolymers are commercially available under a variety of trade designations including, e.g., L-MODU S400 S410, S610 and S901, propylene homopolymers from Idemitsu Kosan Co., Ltd. (Japan).

The polymer can be a styrene block copolymer. The styrene block copolymer has at least one A block that includes styrene and at least one B block that includes, e.g., elastomeric conjugated dienes (e.g., hydrogenated and unhydrogenated conjugated dienes), sesquiterpenes (e.g., hydrogenated and nonhydrogenated sesquiterpenes), and combinations thereof. The A blocks and the B blocks bind to one another in any manner of binding such that the resulting copolymer exhibits a variety of structures including, e.g., random, straight-chained, branched, radial, star, comb, tapered, and combinations thereof. The block copolymer can exhibit any form including, e.g., linear A-B block, linear A-B-A block, linear A-(B-A)n-B multi-block, and radial (A-B)n-Y block where Y is a multivalent compound and n is an integer of at least 3, tetrablock copolymer, e.g., A-B-A-B, and pentablock copolymers having a structure of A-B-A-B-A. The adhesive composition can include blends of at least two different block copolymers.

Suitable styrene A blocks include, e.g., styrene, alpha-methylstyrene, o-methylstyrene, m-methylstyrene, p-methylstyrene, p-tert-butylstyrene, 2,4-dimethylstyrene, 2,4,6-trimethylstyrene, and combinations thereof.

Suitable block elastomeric conjugated diene B blocks include, e.g., butadiene (e.g., polybutadiene), isoprene (e.g., polyisoprene), 2,3-dimethyl-1,3-butadiene, 1,3-pentadiene, 1,3-hexadiene, and combinations thereof, and hydrogenated versions thereof including, e.g., ethylene, propylene, butylene and combinations thereof. Suitable B block sesquiterpenes include, e.g., beta farnesene.

Useful styrene block copolymers include, e.g., styrene-butadiene (SB), styrene-butadiene-styrene (SBS), styrene-isoprene block (SI), styrene-isoprene-styrene (SIS), styrene-ethylene-butylene-styrene (SEBS), styrene-ethylene-propylene-styrene (SEPS), styrene-isobutylene-styrene, and combinations thereof. Particularly useful block copolymers include styrene-butadiene-styrene, styrene-isoprene-styrene, and combinations thereof.

Useful block copolymers are commercially available under the KRATON D series of trade designations, KRATON MD 1537, a high styrene content, styrene ethylene/butylene-styrene block copolymer, and KRATON FG-1901, a functionalized block copolymer from Kraton Corporation, from (Houston, Tex.), EUROPRENE Sol T trade designation from EniChem (Houston, Tex.), VECTOR series of trade designations from Taiwan Synthetic Rubber Corporation (TSRC) (Taipei City, Taiwan) including VECTOR 4211 and DPX-660 styrene-isoprene-styrene block copolymers and SOLPRENE trade designation from Dynasol Group (Mexico) including SOLPRENE 411 and SOLPRENE 1205.

### Tackifying Agent

The hot melt adhesive composition includes a first tackifying agent and a second tackifying agent.

The first tackifying agent and the second tackifying agent are bio-based. The first tackifying agent and second tackifying agent can be entirely bio-based.

Useful first and second tackifying agents can include terpenes, modified terpenes and hydrogenated versions thereof; natural rosins, modified rosins, rosin esters, and hydrogenated versions thereof; low molecular weight polylactic acid; and combinations thereof.

The first and second tackifying agent can be modified with materials such styrene, phenol, carboxylic acids, anhydrides (e.g., maleic anhydride) and combinations thereof.

The hot melt adhesive composition includes a total tackifier content of at least 65% by weight, at least 70% by weight, at least 75% by weight, from 60% by weight to 85% by weight, from 65% by weight to 95% by weight, from 65% by weight to 85% by weight, from 70% by weight to 80% by weight, from 75% by weight to 85% by weight, or even from 75% by weight to 95% by weight.

The hot melt adhesive composition can include from 10% by weight to 30% by weight of the first tackifying agent and from 45% by weight to 65% by weight of the second tackifying agent.

The hot melt adhesive composition can alternatively include from 40% by weight to 65% by weight of the first tackifying agent and from 10% by weight to 25% by weight of the second tackifying agent.

The hot melt adhesive composition can alternatively include from 15% by weight to 65% by weight of the first tackifying agent and from 10% by weight to 75% by weight of the second tackifying agent.

Examples of useful natural and modified rosins include gum rosin, wood rosin, tall oil rosin, distilled rosin, hydrogenated rosin, dimerized rosin and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, and phenolic-modified pentaerythritol esters of rosin.

Examples of useful terpene and modified terpenes include those derived from alpha-pinene, beta-pinene, gamma-limonene, dipentene, or mixtures thereof.

Other useful tackifying agents include oligomeric resins derived from other biosources such as isosorbide, isomannide, and lignin.

First Tackifying Agent

The first tackifying agent is solid at room temperature (18-26° C.). The first tackifying agent has a Ring and Ball Softening Point of at least 80° C., at least 90° C., from 80° C. to 140° C., or even from 80° C. to 105° C. The first tackifying agent can include one or more tackifying agents.

The hot melt adhesive composition can include from 10% by weight to 70% by weight, from 10% by weight to 65% by weight, from 15% by weight to 50% by weight, from 40% by weight to 65% by weight, from 45% by weight to 70% by weight, or even from 10% by weight to 30% by weight of the first tackifying agent.

Useful first tackifying agents are commercially available under a variety of trade designations including rosin ester tackifying agents available under the SYLVALITE trade designation from Kraton Corporation (USA) such as e.g. SYLVALITE RE 100L and SYLVALITE RE 105L and under the KOMOTAC trade designation from Guangdong Komo Co. Ltd. such as e.g. KOMOTAC KM-100 and terpene tackifying agents available under the PICCOLYTE trade designation from DRT (France) such as PICCOLYTE S85 and PICCOLYTE F105IG.

Second Tackifying Agent

The second tackifying agent is a liquid at room temperature (18-26° C.). The word liquid as used herein includes material that are semi-solid. The second tackifying agent has a Ring and Ball Softening Point of no greater than 40° C., no greater than 35° C., no greater than 30° C., from −5° C. to 40° C., or even from 0° C. to 30° C. The second tackifying agent can be present at a greater amount that the first tackifying agent. The second tackifying agent can include one or more tackifying agents.

The hot melt adhesive composition can include from 10% by weight to 80% by weight, from 10% by weight to 75% by weight, from 10% by weight to 70% by weight, from 20% by weight to 67% by weight, from 45% by weight to 65% by weight, from 10% by weight to 25% by weight, or even from 50% by weight to 60% by weight of the second tackifying agent.

Useful second tackifying agents are commercially available under a variety of trade designations including rosin ester tackifying agents available under the SYLVALITE and terpene resins available under the SYLVARES trade designations both from Kraton Corporation (USA) such as e.g. SYLVALITE RE 10 L and SYLVARES TR A25L and rosin ester tackifying agents such as HERCOLYN D and terpene tackifying agents such as PICCOLYTE A25 and DERCOLYTE LTG available from DRT (France)

### Plasticizer

The hot melt adhesive composition can optionally include a plasticizer. The plasticizer can be bio-based. In one embodiment, the only plasticizer present is bio-based.

Suitable plasticizers include, e.g., naphthenic oils, paraffinic oils (e.g., cycloparaffin oils), mineral oils, phthalate esters, adipate esters, olefin oligomers (e.g., oligomers of polypropylene, polybutene, and hydrogenated polyisoprene), polybutenes, polyisoprene, hydrogenated polyisoprene, polybutadiene, benzoate esters, derivatives of oils, glycerol esters of fatty acids, polyesters, polyethers, solid plasticizers (e.g. benzoates) and combinations thereof.

Suitable bio-based plasticizers include animal oil, plant oil (e.g. canola oil, corn oil, soybean oil, epoxidized soybean oil, palm oil, peanut oil, olive oil, sunflower oil, rapeseed oil, jatropha oil, coconut oil, castor oil, etc.), lactic acid derivatives, modified versions thereof and combinations thereof.

The plasticizer is present at no greater than 35% by weight, no greater than 20% by weight, no greater than 18% by weight, no greater than 15% by weight, no greater than 10% by weight, from 2% by weight to 30% by weight, from 2% by weight to 25% by weight, from 2% by weight to 20% by weight, from 2% by weight to 15% by weight, or even from 2% by weight to 10% by weight.

The inventors have discovered that limited amounts of bio-based plasticizers can be helpful to increase the bio-based content of the hot melt adhesive composition, however when too much of the currently available bio-based plasticizers are used staining can result.

Useful plasticizers are currently available under a variety of trade designations including vegetables oils under the ALNOR trade designation from Alnor Oil Company (Valley Steam, N.Y.) including e.g. ALNOR Canola Oil and ALNOR Corn Oil and white mineral oil under the PURETOL trade designation from Petro-Canada Lubricants Inc. (Mississauga, Ontario) including e.g. PURETOL 35

### Wax

The hot melt adhesive composition can be free of a wax, alternatively the hot melt adhesive composition can include a wax. As with the polymer, the wax can be bio-based.

Useful classes of wax include, e.g., paraffin waxes, microcrystalline waxes, high density low molecular weight polyethylene waxes, by-product polyethylene waxes, polypropylene waxes, Fischer-Tropsch waxes, oxidized Fischer-Tropsch waxes, functionalized waxes such as acid, anhydride, and hydroxyl modified waxes, animal waxes, vegetable waxes (e.g. soy wax) and combinations thereof.

Useful waxes are solid at room temperature and preferably have a Ring and Ball softening point of from 50° C. to 170° C.

The wax can be a propylene based wax with a Mettler Softening Point of greater than 130° C., greater than 140° C., or even greater than 150° C. Useful waxes are commercially available from a variety of suppliers including polypropylene and polyethylene waxes available under the EPOLENE N and C series of trade designations from Westlake Chemical Corporation (Houston, Tex.) including e.g. EPOLENE N-21, EPOLENE N-15 and polypropylene and polyethylene waxes available under the LICOCENE series of trade designations from Clariant International Ltd. (Muttenz, Switzerland) including e.g. LICOCENE PP 6102, LICOCENE PP 6502 TP and LICOCENE PP 7502 TP.

The hot melt adhesive composition can include no greater than 10% by weight, no greater than 5% by weight, from 2% by weight to 10% by weight, or even from 3% to 8% by weight wax.

### Additional Components

The hot adhesive composition optionally includes additional components including, e.g., petroleum derived tackifying agents, additional polymers (e.g. acrylic copolymers and block copolymers available from Kuraray, Co. Ltd. (Korea) under the KURARITY trade designation such as e.g. KURARITY LA3320, LA2330, and LA2250), stabilizers, antioxidants, adhesion promoters, ultraviolet light stabilizers, colorants (e.g., pigments and dyes), fillers, surfactants, co-extrusion coatings, packaging films, wetness indicators, superabsorbents and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants and IRGAFOS 168 phosphite antioxidant, all of which are available from BASF Corporation (Florham Park, N.J.), and Ethyl 702 4,4′-methylene bis(2,6-di-tert-butylphenol). When present, the adhesive composition preferably includes from 0.1% by weight to 3% by weight antioxidant.

### Uses

The hot melt adhesive compositions of this invention can be used in many different applications and for a variety of end uses including pressure sensitive adhesives (e.g. removable and permanent types), bookbinding adhesives, adhesives to attach inserts to published materials (e.g. magazines), adhesives to assemble various items (e.g. filters), adhesives for packaging constructions (e.g. cases, cartons, trays, etc.), adhesives for tapes and labels, and adhesives for disposable articles.

### Tapes and Labels

The hot melt adhesive compositions of this invention can be used to make adhesive tapes or alternately to adhere labels to various items (e.g. containers, magazines, etc.). The label/tape can be selected from a variety of materials including paper, non-paper films (e.g. polypropylene (e.g. polypropylene (PP), oriented polypropylene (OP), and biaxially oriented polypropylene (BOPP)), polyethylene, etc.). The container can be metal (e.g. aluminum or steel) or plastic (polyethylene terephthalate (PET), high density polyethylene (HDPE) and polypropylene.

The label can be a spot label i.e. a label that does not extend completely around the container. Alternatively, the label can be a wraparound label i.e. a label that completely wraps around the entire container.

If the label is a wraparound label, it can be roll fed into the applicator. Alternatively, the labels are pre-cut and fed in from a stack. In a wraparound label application method, the label stock is fed into a label station. A pick-up adhesive and a lap glue are then applied to the label, often from the same glue pot. A pick-up adhesive adheres the leading edge of the label to a container. The lap glue then bonds the overlap where the wrap around label overlaps itself. The hot melt adhesive composition of this invention can be both the pick-up adhesive and the lap glue.

### Disposable Absorbent Articles

The hot melt adhesive composition can be applied to (i.e. such that it is in direct contact with) or incorporated in a variety of substrates including, e.g., films (e.g., polyolefin (e.g., polyethylene and polypropylene), bio-based films), release liners, porous substrates, cellulose substrates, sheets (e.g., paper, and fiber sheets), paper products, woven and nonwoven webs, fibers (e.g., synthetic polymer fibers and cellulose fibers) and tape backings.

The hot melt adhesive composition is also useful in a variety of applications and constructions including, e.g., disposable absorbent articles including, e.g., disposable diapers, adult incontinence products, sanitary napkins, medical dressings (e.g., wound care products) bandages, surgical pads, pet training pads (e.g. puppy pads) and meat-packing products and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue) and elastics.

The hot melt adhesive composition is useful on substrates made from a variety of fibers including, e.g., natural cellulose fibers (e.g. wood pulp, cotton, viscose, starch, etc.), silk, PLA (poly lactic acid), PHA (poly hydroxyl alkanoates), PBS (poly butylene succinate), PBAT (poly butylene adipate terephthalate) and wool; synthetic fibers such as nylon, rayon, polyesters, acrylics, polypropylenes, polyethylene, polyvinyl chloride, polyurethane, and glass; recycled fibers, and various combinations thereof.

The hot melt adhesive composition is useful on a variety of films including polyethylene, polypropylene, ethylene vinyl acetate, ethylene copolymer, bio-based films (e.g. PLA, PH A, starch, etc.).

Various application techniques can be used to apply the composition to a substrate including, e.g., slot coating, spraying including, e.g., spiral spraying and random spraying, screen printing, foaming, engraved roller, extrusion and melt blown application techniques.

### Methods of Making Disposable Absorbent Articles

The hot melt adhesive compositions of this invention can be used in a wide variety of applications within the disposable absorbent article. The hot melt adhesive compositions can be used as construction adhesives (e.g. used to bond the back sheet to the nonwoven and optionally the absorbent pad), as a positioning adhesives (e.g. to adhere a disposable absorbent article to an undergarment), as an elastic attachment adhesive (e.g. bonding the elastic material to the back sheet in for example the leg or waist area), or to attach elastic material to any other portion of the article, and for core stabilization (e.g. applying a hot melt composition to the absorbent core to increase the strength of the core).

The hot melt adhesive composition can be used for construction applications. In a typical construction application in the manufacture of a disposable absorbent article, a body fluid impermeable back sheet is bonded to a nonwoven substrate. The hot melt adhesive composition may also be used to bond at least one additional layer or material selected from the group consisting of absorbents, tissues, elastomeric materials, superabsorbent polymers, and combinations thereof. For example, the adhesive can further be used for back sheet lamination i.e. where the body fluid impermeable backsheet typically a film (e.g. polyethylene, polypropylene, ethylene vinyl acetate, ethylene copolymer, bio-based etc.) is bonded to a second nonwoven to improve the feel of the disposable article.

The hot melt adhesive composition can be used as a positioning adhesive. A positioning adhesive is disposed on at least one substrate surface of a disposable absorbent article and can be used to position an absorbent article on a garment such as underwear. Such disposable absorbent articles include, e.g., feminine hygiene articles such as sanitary napkins and panty liners, diapers, disposable garments having a waist opening and leg openings, and adult incontinence articles. In one construction, the absorbent article (e.g., a feminine hygiene article) includes a garment facing surface and a body facing surface, a topsheet having a garment facing surface and a body facing surface, a backsheet having a garment facing surface and a body facing surface, and an absorbent core disposed between the body facing surface of the backsheet and the garment facing surface of the topsheet. The pressure-sensitive adhesive composition is disposed on the garment facing surface of the adsorbent article, in general, or even on the garment facing surface of the backsheet. A release liner optionally is disposed on the pressure-sensitive hot melt adhesive composition to protect the pressure-sensitive adhesive composition until use. The absorbent article (e.g., a feminine hygiene article) optionally includes additional layers and adhesives and the components of the absorbent article optionally exhibit additional functionality. Examples of additional layers, functionality and combinations thereof include dusting, wicking, acquisition, additional top sheets, multiple core layers, superabsorbent particles and compositions, wetness indicators, and combinations thereof.

The hot melt adhesive can further be used for bottle labeling or for tape &label applications.

The invention will now be described by way of the following examples. All parts, ratios, percents and amounts stated in the Examples are by weight unless otherwise specified.

### Examples

### Test Procedures

Test procedures used in the examples and throughout the specification, unless stated otherwise, include the following.

### Brookfield Viscosity Test Method

Viscosity is determined in accordance with ASTM D-3236 entitled, “Standard Test Method for Apparent viscosity of Adhesives and Coating Materials,” (Oct. 31, 1988), using a Brookfield Thermosel viscometer Model RVDV 2 and a number 27 spindle. The results are reported in centipoise (cP).

### Peel Test Sample Preparation Method

Peel test samples were prepared in two different way. For both methods, each hot melt adhesive was applied to substrates with a slot or spray hot melt applicator set to an application temperature of 115-140° C., the lamination equipment was set with minimal rewind and unwind tensions so as not to stretch the film. For both methods, each hot melt adhesive was applied at a speed of from 190 meters per minute (m/min) to 230 m/min. Both substrates were traveling at the same speed and after the hot melt adhesive was applied the hot melt adhesive coated side was mated with the second substrate by a non-pressured nip.

In preparation method A, the hot melt adhesive composition was applied continuously with a spray applicator using a spiral spray pattern that was 1 in wide (25.4 mm) at a coat weight of 4 g/m². For preparation method A, the hot melt adhesive was applied to an embossed non-breathable, layered polyethylene film having a thickness of 0.9 mil (0.23 mm) and laminated with an oriented polypropylene nonwoven web having a thickness of 4 mils (0.1 mm) and a basis weight of 0.45 ounces per square yard (15.3 g/m²). The laminate is then cut as strips of 1 inch in width, along the machine direction (MD) of the coater.

In preparation method B, the hot melt adhesive composition was applied continuously with a slot applicator in a comb shim pattern that was 7.62 centimeters (cm) (3 inches (in)) wide, and teeth of the comb shim spaced 1 mm on and 1 mm off, at a coat weight of 6 g/m² in the adhesive area. Hot melt adhesives applied with preparation method B were applied to an oriented cotton nonwoven web having a thickness of 16 mils and a basis weight of 20 g/m² and laminated to an embossed non-breathable, layered polyethylene film having a thickness of 0.9 mil (0.023 mm). The adhesive was applied at a speed of from 80 meters per minute (m/min) to 120 m/min. The laminate was then cut as strips of 7.62 cm (3 in) in width, along the machine direction (MD) of the coater.

### Dynamic Peel Test Method

Dynamic Peel was determined per ASTM D1876-01 entitled, “Test Method for Determining Peel Resistance of Adhesive (T-Peel Test Method),” with the exception that the test was run at 30.5 centimeters per minute (12 inches per minute) over a period of 10 seconds and 6 replicates were run. The samples were run on an IMASS Spec-type test instrument. The samples were peeled along the machine coating direction. The average peel value over 10 seconds of peeling was recorded, and the results were reported in grams. The initial Dynamic Peel value is the value measured 24 hours after the sample is prepared. Six replicates were tested and the average value were reported in units of grams of force per centimeter (gf/cm).

### Wet Dynamic Peel

Samples coated on cotton using Preparation Method B were tested both in their dry form (initial peel method above) and wetted to represent adhesion performance after article insult. Wet samples were prepared by soaking the sample in 0.9 wt % NaCl solution for 1 minute and then following the “dynamic peel test method”. 0.9 wt % NaCl solution was prepared using DI water and NaCl.

### Aged Dynamic Peel

Peel samples prepared by Preparation Method A and Preparation Method B were aged as stated (e.g. 2 weeks and 4 weeks) in an incubator oven set to 50° C. Sample testing after aging was the same as listed above.

### Glass Transition Temperature (Tg) by Dynamic Mechanical Analysis (DMA)

The glass transition temperature (Tg) was determined according to ASTM D7028. The DMA is conducted using a DHR-II instrument and “Advantage for Q Series Version” software or equivalent. The instrument is set to DMA strain-controlled mode and temperature sweep.

The sample is placed in tension mode in the DMA instrument at a preload force of 0.01 N. The test sample is equilibrated at 130° C., is held at 130° C. for 5 minutes (min) and then the temperature is decreased to a final temperature of −10° C. at a temperature cooling rate of 10° C./min and a frequency of 10 radians per second (1.59 Hertz), conditioned at 0° C. for 10 minutes, and then heated to 130° C. at a rate of 3° C./min and a frequency of 10 radians per second (1.59 Hertz). The Tg is recorded as the first maximum temperature value for Tan Delta (G″/G′) during the heating cycle (i.e., the cycle from −10 CC to 130° C.).

If the viscosity of the sample to be tested is less than 5000 cP at 121° C., then the above-described DMA method is modified as follows: the equilibration temperature and the first hold temperature are both 120 CC instead of 130 CC, and the sample heating cycle is from −10° C. to 120° C. instead of −10° C. to 130° C.

TABLE One

| | Control 1 | Control 2 | Ex. 1 | Ex. 2 | Ex. 3 | Ex. 4 | Ex. 5 | Ex. 6 | Ex. 7 |
|---|---|---|---|---|---|---|---|---|---|
| SOLPRENE 411 | | | | | | | | 9 | |
| SOLPRENE 1205 | | | | | | | | 5 | |
| VISTAMAXX 6202 | | | 14 | | | | | | |
| ENGAGE 8200 | | | | 14 | 14 | 9 | 6 | | 14 |
| AFFINITY GA1000R | | | | | | 5 | 9.5 | | |
| PICCOLYTE F105 IG | | | 21.21 | 23 | | 23 | 46 | | 5 |
| SYLVALITE RE 100L | | | | | 12 | | | 63 | 18 |
| PICCOLYTE A25 | | | 57.19 | 55 | 55 | 57 | | | 55 |
| SYLVALITE RE 25 | | | | | 11 | | | | |
| DERCOLYTE LTG | | | | | | | 24 | 13.8 | |
| ALNOR CANOLA OIL | | | | 5 | 5 | 3 | | 7.5 | 5 |
| ALNOR CORN OIL | | | 5 | | | | | | |
| PURETOL 35 | | | | | | | 12 | | |
| EPOLENE N-21 | | | 1 | 1 | 1 | 1 | 2 | | 1 |
| SARAWAX SX 105 | | | 1.4 | 1.2 | 1.2 | 1.2 | | 1.2 | 1.2 |
| ANTIOXIDANT | | | 0.2 | 0.8 | 0.8 | 0.8 | 0.5 | 0.5 | 0.8 |
| BIO-BASED | 0% | 0% | 83.4% | 83% | 83% | 83% | 70% | 84% | 83% |
| COMPONENTS | | | | | | | | | |
| (weight %) | | | | | | | | | |
| Brookfield Viscosity @ | | | | 16080 | 14780 | 5867 | | 88100 | |
| 107° C. (225° F.) - cP | | | | | | | | | |
| Brookfield Viscosity @ | 14350 | | | 8663 | 7983 | 2944 | 3150 | 32540 | |
| 121° C. (250° F.) - cP | | | | | | | | | |
| Brookfield Viscosity @ | 7350 | | | 4863 | 4588 | 1734 | 1725 | 15750 | |
| 135° C. (275° F.) - cP | | | | | | | | | |
| Dynamic Peels | | | | | | | | | |
| Preparation method A | | | | | | | | | |
| Initial (gf/cm) | 174 | | 117 | 109 | 128 | | 203 | 168 | 126 |
| Aged 2-weeks (gf/cm) | 286 | | 184 | 141 | 219 | | 187 | 330 | 149 |
| Aged 4-weeks (gf/cm) | 275 | | 208 | 106 | 183 | | 112 | 377 | 131 |
| Dynamic Peels | | | | | | | | | |
| Preparation method B | | | | | | | | | |
| Initial (gf/cm) | | 259 | | 361 | 299 | 492 | 582 | 640 | |
| Wet (gf/cm) | | 23 | | 32 | 40 | 144 | 92 | 45 | |

Control 1 is NW 1137, an ethylene single-site catalyzed polymer based hot melt adhesive composition commercially available from HB Fuller. Control 2 is Full-Care 5151N, a styrene block copolymer and ethylene single-site catalyzed polymer based hot melt adhesive composition commercially available from HB Fuller.

TABLE TWO

| | Ex 8 | Ex. 9 | Ex. 10 | Ex. 11 | Ex. 12 |
|---|---|---|---|---|---|
| KRATON | 5 | 5 | 6 | 6 | 5 |
| MD1537 | | | | | |
| SYLVALITE | 44.5 | 34.5 | 22 | 18 | 18 |
| RE100L | | | | | |
| SYLVARES A | 50 | 60 | 69.5 | 72.5 | 73.5 |
| TR 25 | | | | | |
| EPOLENE | | | 2 | 3 | 3 |
| N21 | | | | | |
| IRGANOX | 0.5 | 0.5 | 0.5 | 0.5 | 0.5 |
| 1010 | | | | | |
| BIO-BASED | 94.5 | 94.5 | 91.5 | 90.5 | 91.5 |
| COMPONENT | | | | | |
| (weight %) | | | | | |
| Brookfied | 3,763 | 1,630 | 1,185 | 1,150 | 655 |
| Viscosity @ | | | | | |
| 107° C. (cP) | | | | | |
| Tg (° C.) | 37 | 28 | 25 | 19 | 21 |

The adhesive compositions were prepared by combining and mixing the components in the percentages set forth in Table 2 in a sigma blade mixer operating at 177° C.

What is claimed is:

1. A hot melt adhesive composition comprising:
a. a thermoplastic polymer,
b. a first tackifying agent that is bio-based and solid at room temperature, and
c. a second tackifying agent that is bio-based and liquid at room temperature, wherein the hot melt adhesive composition comprises greater than 70% by weight of bio-based components and wherein the second tackifying agent is present in a greater amount than the first tackifying agent.

2. The hot melt adhesive composition of claim 1 comprising a total tackifying agent content of 65% by weight to 95% by weight.

3. The hot melt adhesive composition of claim 1 wherein the first and second tackifying agents are selected from the group consisting of terpenes, modified terpenes, natural rosins, modified rosins, rosin esters and hydrogenated versions thereof.

4. The hot melt adhesive composition of claim 1 comprising from 15% by weight to 65% by weight of the first tackifying agent and from 10% by weight to 75% by weight of the second tackifying agent.

5. The hot melt adhesive composition of claim 1 further comprising a bio-based plasticizer.

6. The hot melt adhesive composition of claim 5 wherein the bio-based plasticizer is derived from a plant oil.

7. The hot melt adhesive composition of claim 1 wherein the thermoplastic polymer is selected from the group consisting of propylene based polymers, ethylene based polymers and styrene block copolymers.

8. The hot melt adhesive composition of claim 1 wherein the thermoplastic polymer is single site catalyzed.

9. The hot melt adhesive composition of claim 1 wherein the thermoplastic polymer comprises a functionalized polymer.

10. The hot melt adhesive composition of claim 1 wherein the thermoplastic polymer is selected from the group consisting of bio-based, recycled, and combinations thereof.

11. The hot melt adhesive composition of claim 1 wherein the hot melt adhesive composition comprises from 80% by weight to 100% by weight of bio-based components.

12. The hot melt adhesive composition of claim 1 wherein the hot melt adhesive composition comprises 100% by weight of bio-based components.

13. The hot melt adhesive composition of claim 1 comprising:
a. from 3% by weight to 25% by weight of the thermoplastic polymer,
b. from 10% by weight to 70% by weight of the first tackifying agent, and
c. from 10% by weight to 80% by weight of the second tackifying agent.

14. The hot melt adhesive composition of claim 1 having a Brookfield Viscosity of from 2,000 cP to 15,000 cP at 121° C.

15. The hot melt adhesive composition of claim 1 having a Wet Dynamic Peel of from 30 gf/cm to 500 gf/cm.

16. A hot melt adhesive composition comprising:
a. from 3% by weight to 25% by weight of a thermoplastic polymer,
b. from 10% by weight to 70% by weight of a first tackifying agent that is bio-based and solid at room temperature,
c. from 10% by weight to 80% by weight of a second tackifying agent that is bio-based and liquid at room temperature, and
d. optionally less than 25% by weight of a bio-based plasticizer,
wherein the hot melt adhesive composition comprises greater than 80% by weight of bio-based components.

17. An article selected from the group consisting of a tape, a label and a disposable absorbent article comprising the hot melt adhesive composition of claim 1.

18. A disposable absorbent article comprising:
a.) a first substrate,
b.) a second substrate, and
c.) the hot melt adhesive composition of claim 1,
wherein the hot melt adhesive composition is disposed on at least one of the first and second substrates.

19. The disposable absorbent article of claim 18 wherein at least one of the substrates is bio-based.

20. The disposable absorbent article of claim 19 wherein the bio-based substrate is cotton.
